(19) United States
(12) Patent Application Publication
(10) Pub. No.: US 2004/0016158 A1
(43) Pub. Date: Jan. 29, 2004

(54) Mobile advertisement apparatus for vehicle

(76) Inventor: Jae-eul Kim, Seoul (KR)

Correspondence Address: VENABLE, BAETJER, HOWARD AND CIVILETTI, LLP, P.O. BOX 34385, WASHINGTON, DC, 20043-9998, US

(21) Appl. No.: 10/263,184

(22) Filed: Oct. 3, 2002

(30) Foreign Application Priority Data
Jul. 25, 2002 (KR) 2002-43818

(51) Int. Cl. G09F 21/04; G09F 15/00

(52) U.S. Cl. 40/590; 40/610

(57) ABSTRACT

A mobile advertisement apparatus for vehicle is disclosed. The mobile advertisement apparatus for vehicle includes a container package for protecting inside of the container package; a plural of bridges for controlling height and parallel of the container package; a power generator for supplying the power; a rotator for rotating the mobile advertisement apparatus; a lift for performing raising and falling operations; an electronic display board for displaying images of advertisement by having a plurality of emitting objects on one side; an attachable tire; a supporter for bedding the container package to a ground. The present invention can increase an effectiveness of advertisement and economic efficiency by operating the mobile advertisement apparatus independently to the vehicle used as carrying the mobile advertisement apparatus.

### FIELD OF THE INVENTION

The present invention relates to an advertisement apparatus for a vehicle; and, more particularly, to a mobile advertisement apparatus for vehicle in order to operate the mobile advertisement apparatus independently of the vehicle used for carrying the advertisement apparatus for a long distance.

### DESCRIPTION OF RELATED ARTS

Generally, many companies have been advertising their product and corporation image by using a mass media such as a television or radio or an outdoor advertising apparatus, which is established on poles or walls in a certain area such as a rooftop of a building or a street side with permission.

The above-mentioned advertisement method with the mass media has been attracted to public since its visual and audio affection. However, it is hard to use the advertisement method with mass media for an outdoor festival or outdoor product promotion campaign and it is also very costless method of advertising.

In case of using the outdoor advertising apparatus, it demands hard labor work to establish or install the advertisement apparatus to an outdoors location and after installing the outdoor advertising apparatus at a fixed location, it cannot be moved. Therefore, an effectiveness of the outdoor advertising apparatus is decreased.

A patent of Korea 1999-59847 teaches an advertisement apparatus with a vehicle for providing mobility to an advertisement apparatus by mounting an electronic display board on the vehicle in order to outdoor advertising.

However, the above-mentioned patent demands a high cost vehicle for carrying the advertisement apparatus such as a big screen electronic display board and an operator of the vehicle during displaying advertisement image at a fixed location.

### SUMMARY OF THE INVENTION

It is, therefore, an object of the present invention to provide a mobile advertisement apparatus for vehicle in order to increase effectiveness of the advertisement and economic efficiency by operating the mobile advertisement apparatus independently of the vehicle, which is used for carrying the mobile advertisement apparatus in a long distance.

In accordance with an aspect of the present invention, there is provided a mobile advertisement apparatus, including: a container package having a rectangular parallelepiped form as outside view with empty internal space and an opening unit equipped on an upper side of the container package for protecting inside of the container package; a plural of bridges being mounted on a left side and right side of the container package and equipping a cylinder load internally for controlling height and horizon of the container package by raising and descending the cylinder load; a power generator being equipped in internal of the container package for supplying the power; a rotator for performing a rotation operation; a lift being equipped at upper side of the rotator and formed as multi-layers variable oil pressure cylinder for performing raising and descending operations; an electronic display board being mounted at upper side of the lift for displaying images of advertisement by having a plurality of emitting objects on one side; an attachable tire being installed at bottom and outside of the plural of bridges as having a rotation axis, which is erectly to a moving direction of the cylinder load, mounted when the container package is moved in a short distance and removed when a vehicle with the mobile advertisement apparatus is moved in a long distance; a supporter 108 being equipped at bottom of the cylinder load equipped at the plural of bridges for bedding the container package to a ground.

### BRIEF DESCRIPTION OF THE DRAWING(S)

The above and other objects and features of the present invention will become apparent from the following description of the preferred embodiments given in conjunction with the accompanying drawings, in which:

FIG. 1A is a cross-sectional view illustrating a mobile advertisement apparatus for vehicle in accordance with a preferred embodiment of the present invention;

FIG. 1B is another cross-sectional view showing a mobile advertisement apparatus for vehicle in accordance with the preferred embodiment of the present invention; and

FIGS. 2A to 2V are views showing operation states of a mobile advertisement apparatus for vehicle in accordance with a preferred embodiment of the present invention.

### DETAILED DESCRIPTION OF THE INVENTION

Other objects and aspects of the invention will become apparent from the following description of the embodiments with reference to the accompanying drawings, which is set forth hereinafter.

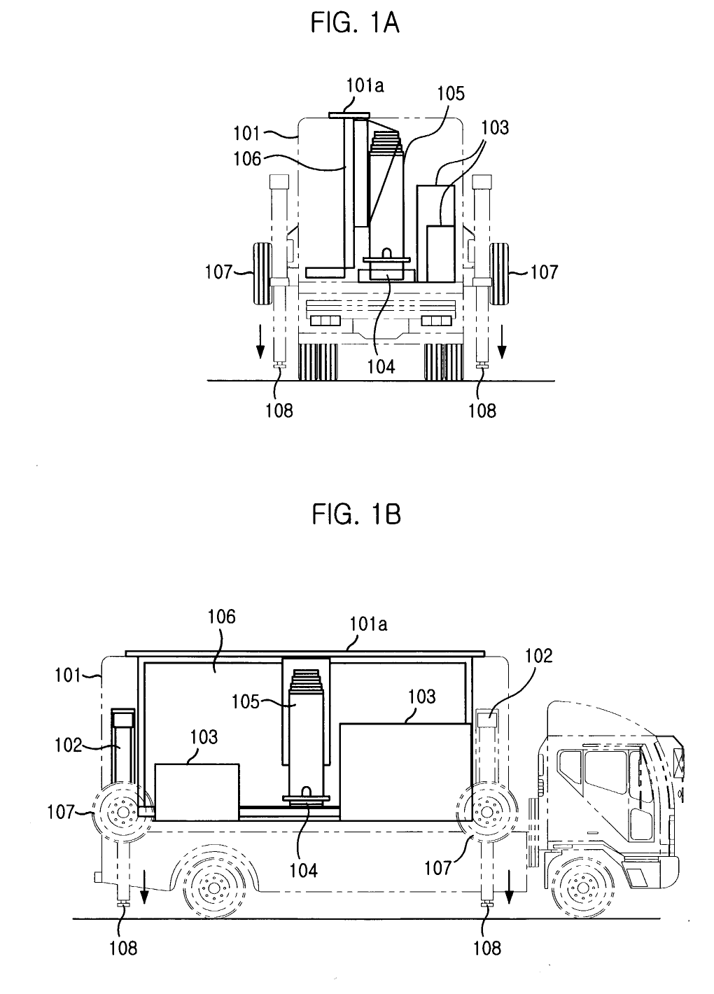

FIG. 1A is a cross-sectional view illustrating a mobile advertisement apparatus for vehicle in accordance with a preferred embodiment of the present invention and FIG. 1B is another cross-sectional view showing a mobile advertisement apparatus for vehicle in accordance with the preferred embodiment of the present invention. The mobile advertisement apparatus includes a container package 101, a plural of bridges 102, a power generator 103, a rotator 104, a lift 105, an electronic display board 106, an attachable tire 107 and a supporter 108.

The container package 101 has a rectangular parallelepiped form as outside view with empty internal space. The power generator 103, rotator 104, lift 105 and electronic display board 106 are equipped inside of the container package 101. The plural of bridges 102, attachable tire 107 and supporter 108 are installed outside of the container package 101 and an opening unit 101a operated by the electronic display board 102 is equipped on an upper side of the container package 101. The container package 101 also protects the electronic display board 106 by covering and holding the electronic display board 106 in the internal space of the container package 101. The container package 101 has six sides, an upper side, a bottom side, a front side, a backside, a left side and a right side. The container package 101 may have more than one gate for entering to internal space in order to operation or maintenance. It is desirable to have a length 5.895 m, a width 2.335 m and height 2.390 m as an inside diameters of the container package 101.

The plural of bridges 102 is formed on the left side and right side of the container package 101 by corresponding each other's and a height and horizon is controlled by raising and descending a cylinder load equipped in the plural of bridges 102. It is desirable to equip four bridges 102 at each corner of left and right side of the container package 101.

The power generator 103 is equipped in the internal space of the container package 101 and supplies the power.

The rotator 104 is equipped in the internal space and on the bottom side of the container package 101 and rotates the electronic display board 106 mounted at an upper portion of the lift 105. The rotator 104 can be formed in any structure, if it rotates the lift 105 having a retractable structure. For example of the rotator 104, the rotator 104 can be composed of a first gear, a pinion gear and a motor. The first gear is fixed at the bottom of the lift 105 and the pinion gear is interlocked with the first gear. The motor turns the pinion gear.

The lift 105 is equipped in an upper side of the rotator 104 and formed as a multi-layers variable oil pressure cylinder. The lift 105 supports and moves the electronic display board 106 to up and down. The multi-layers variable oil pressure cylinder obtains the electric power from the power generator 103.

The electronic display board 106 is mounted at upper portion of the lift 105 and has plurality of emitting objects at one side for displaying images of advertisement. The electronic display board 106 is implemented as retractable by using a restoration spring. The electronic display board is retracted when it stays inside of the container package 101. When the electronic display board 106 is exposed to outside, it is extracted.

The attachable tire 107 is installed at bottom and outside of the plural of bridges 102 as having a rotation axis, which is erectly to a moving direction of the cylinder load. It is attached when the container package 101 is moved in a short distance and is removed when the vehicle with the mobile advertisement apparatus is moved in a long distance.

The supporter 108 is equipped at bottom of the cylinder load equipped at the plural of bridges 102 and it beds the container package 101 to a ground.

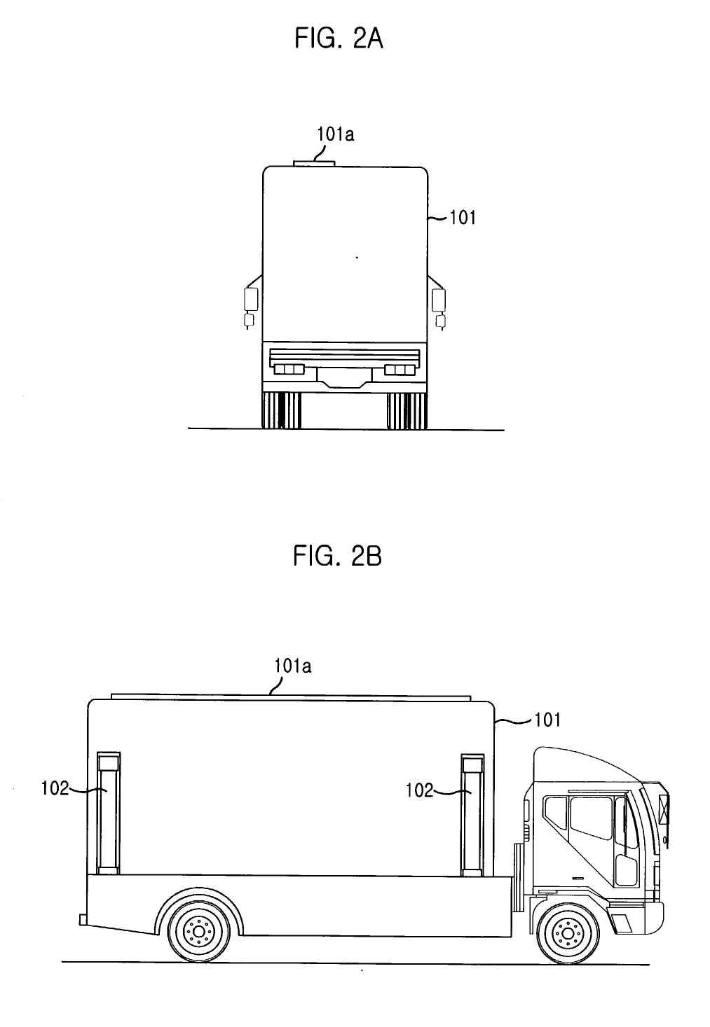

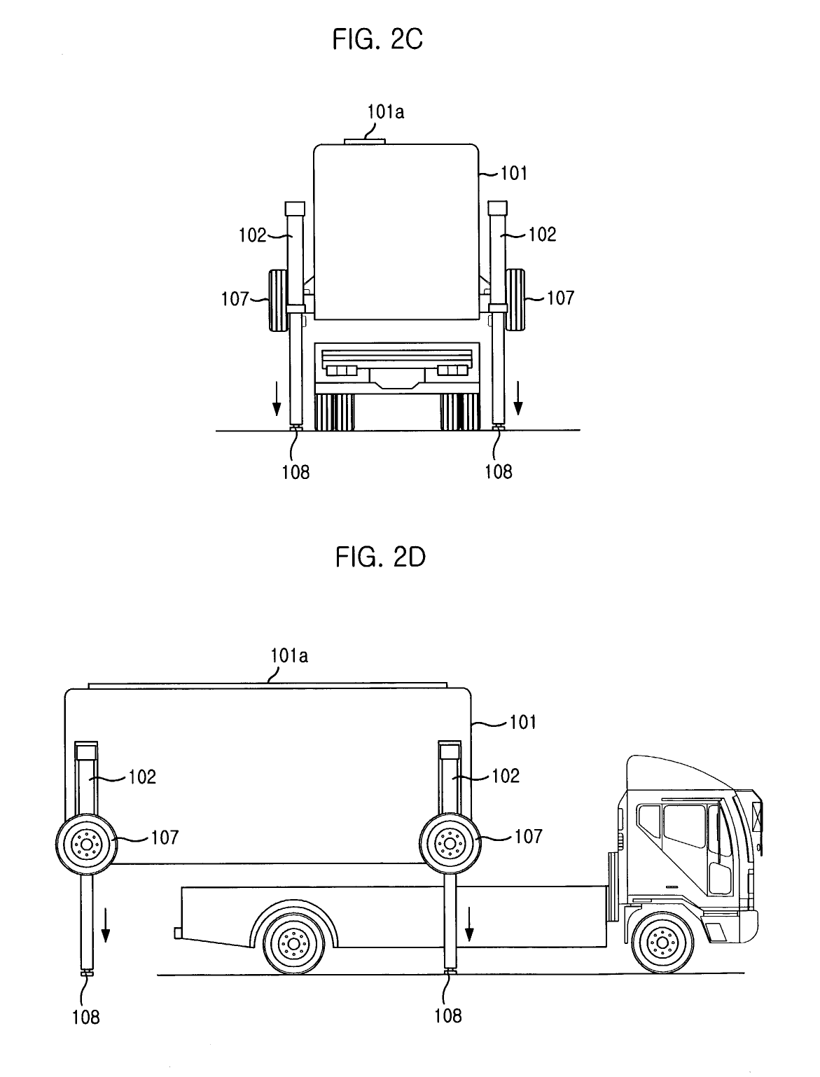

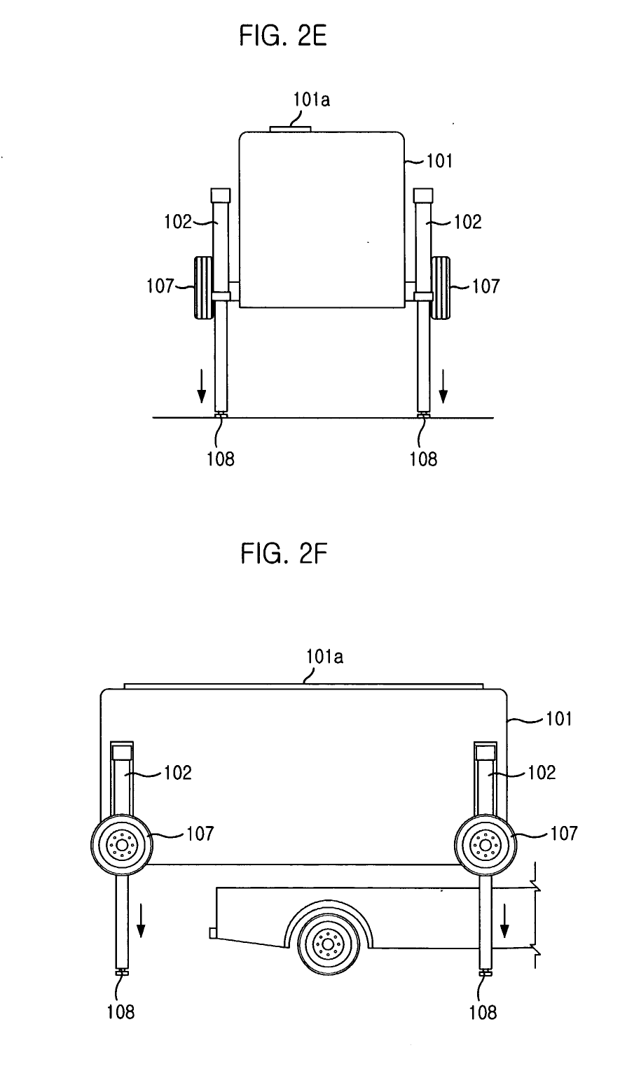

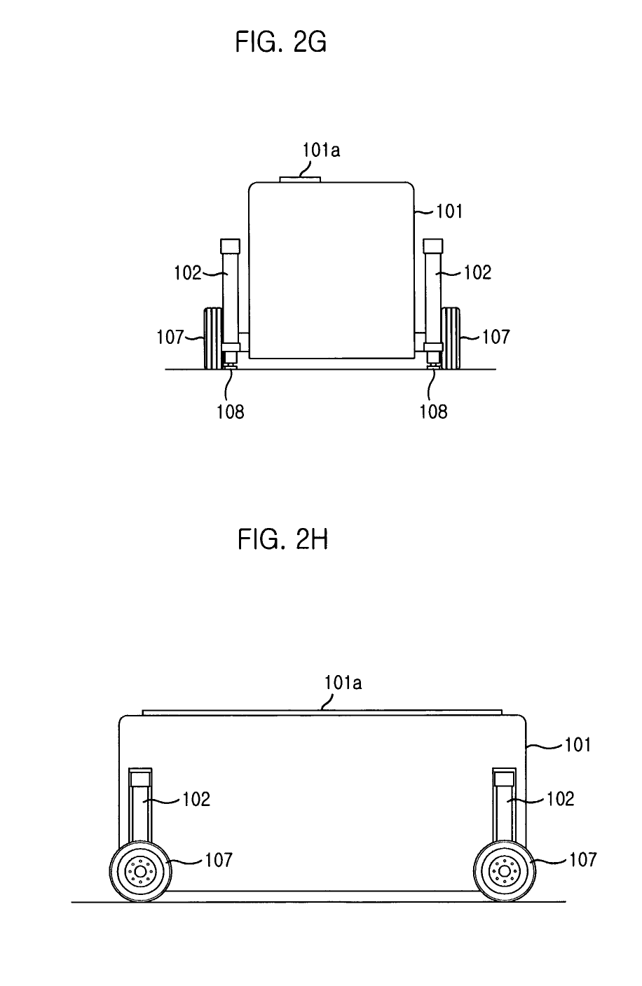

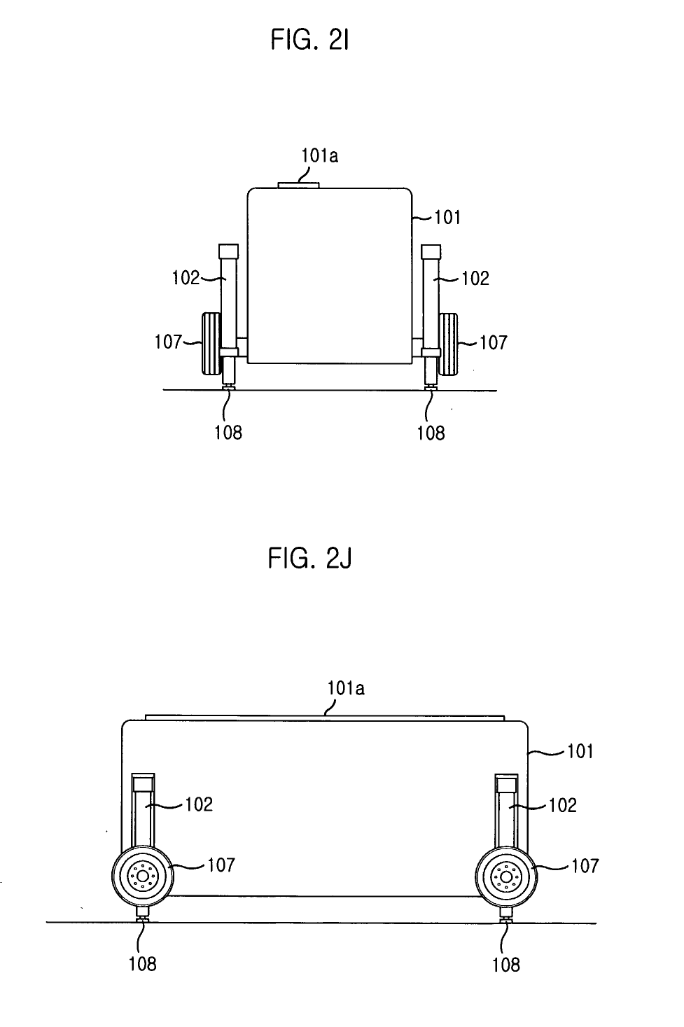

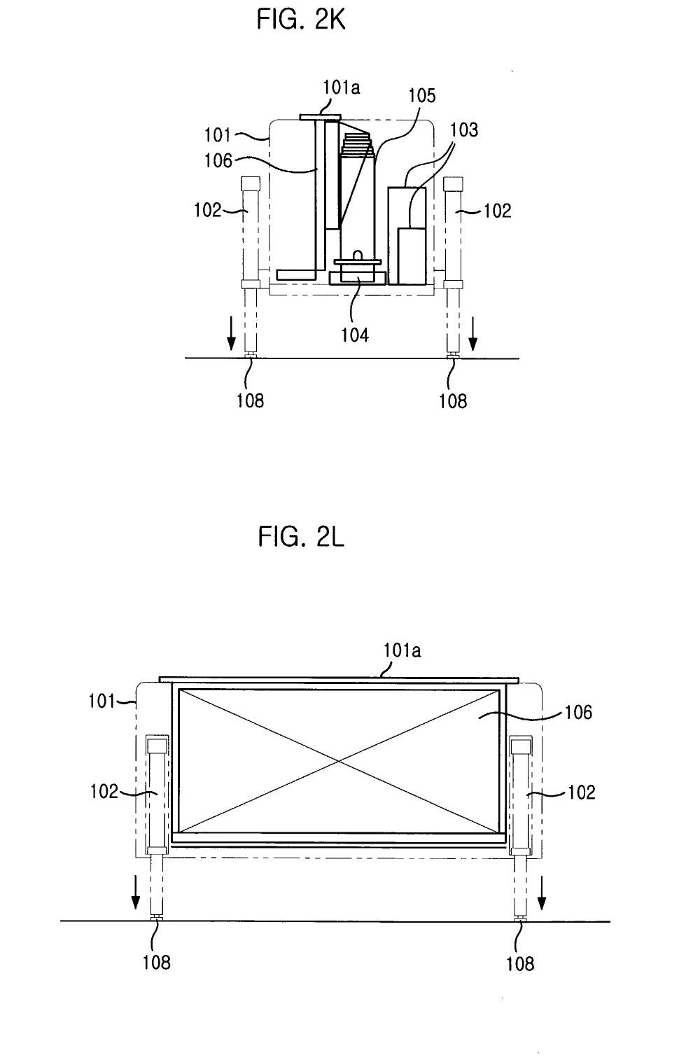

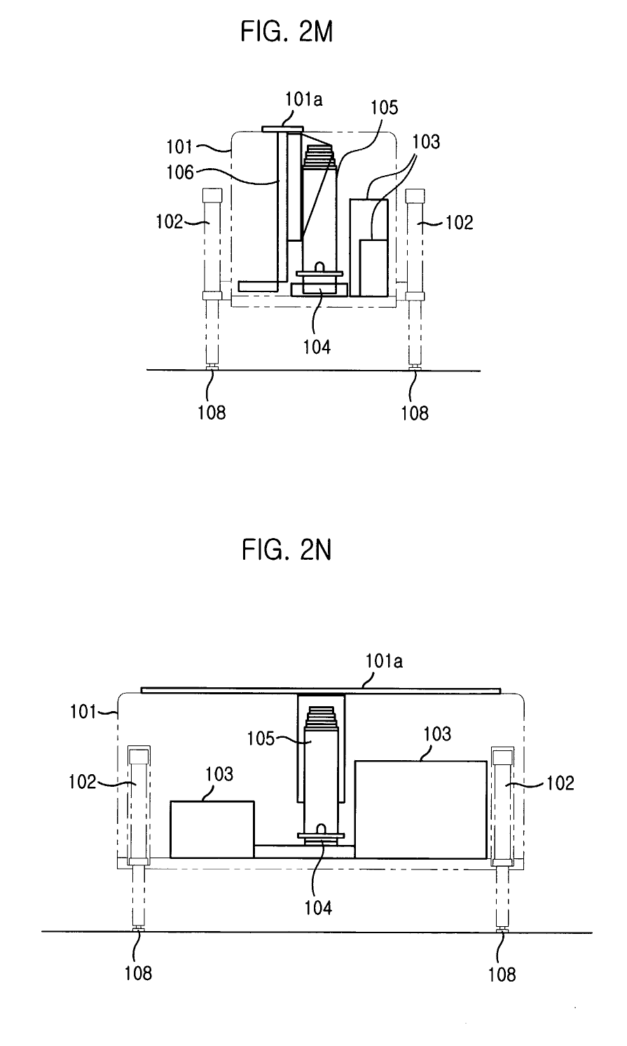

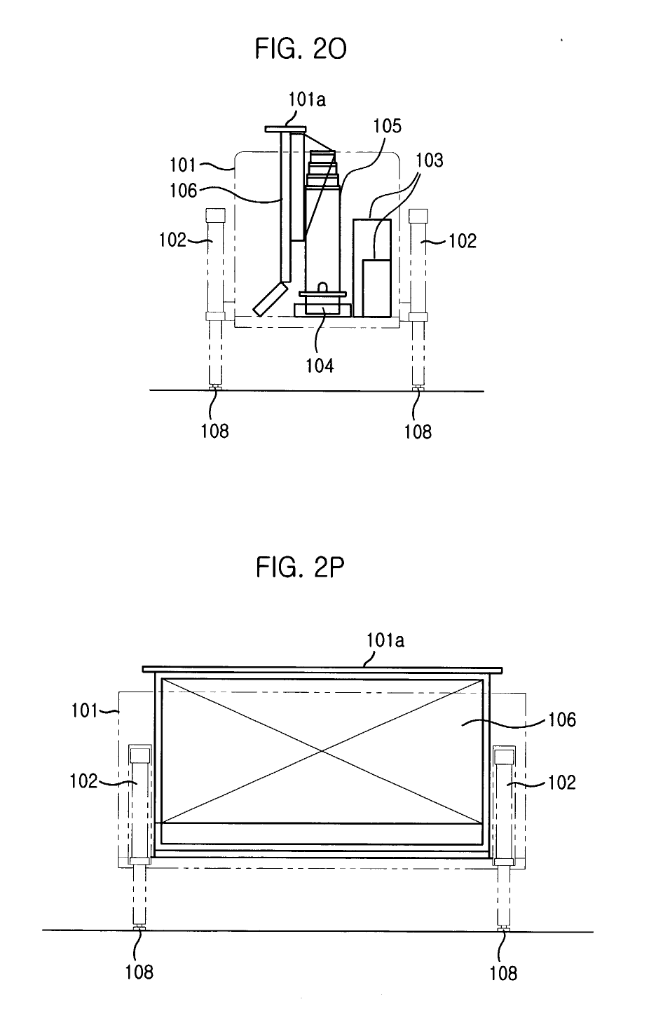

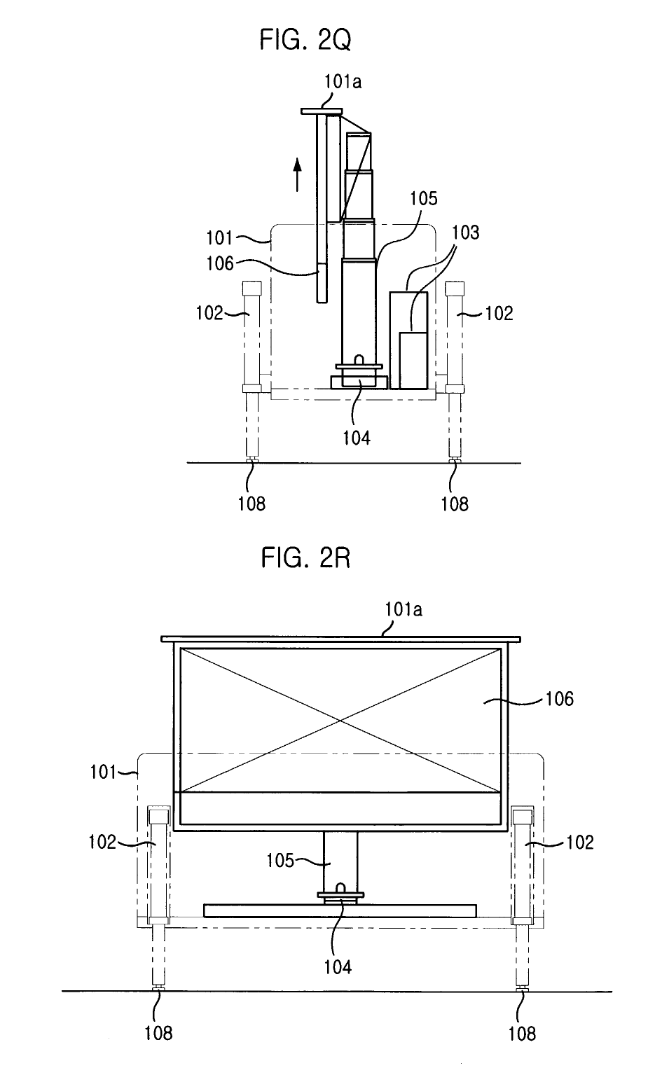

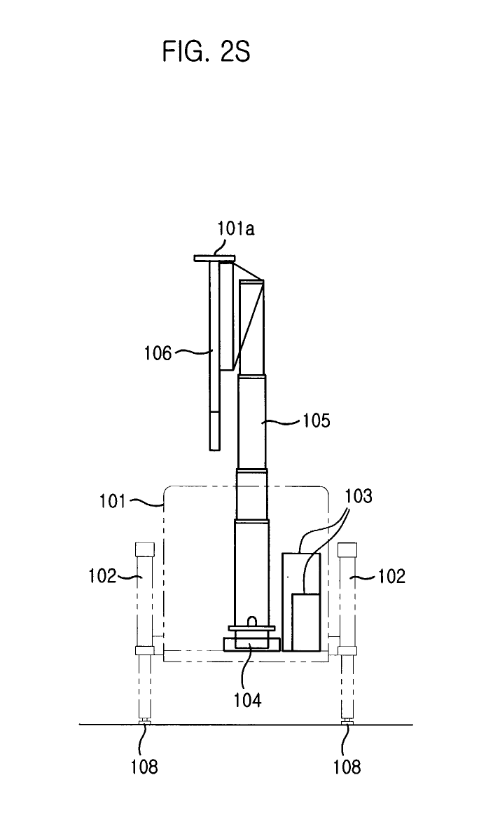

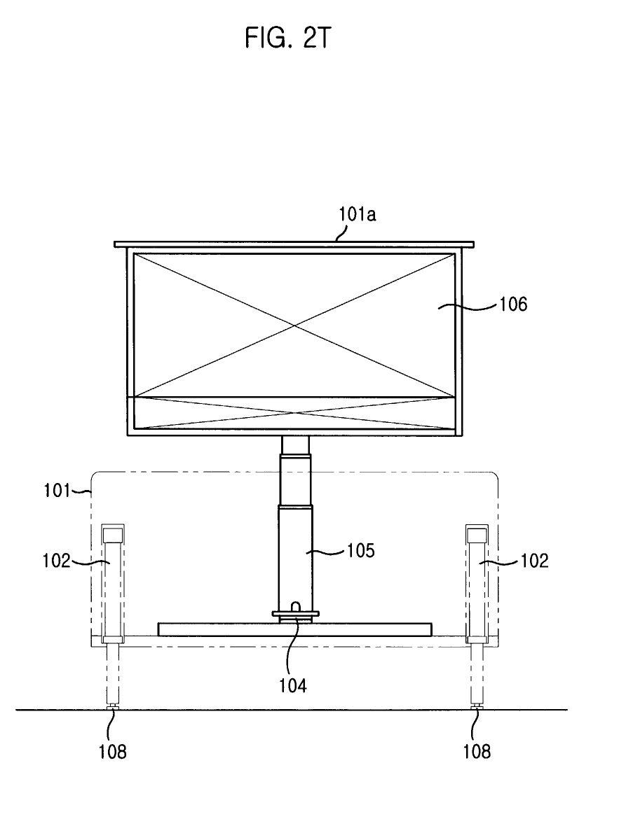

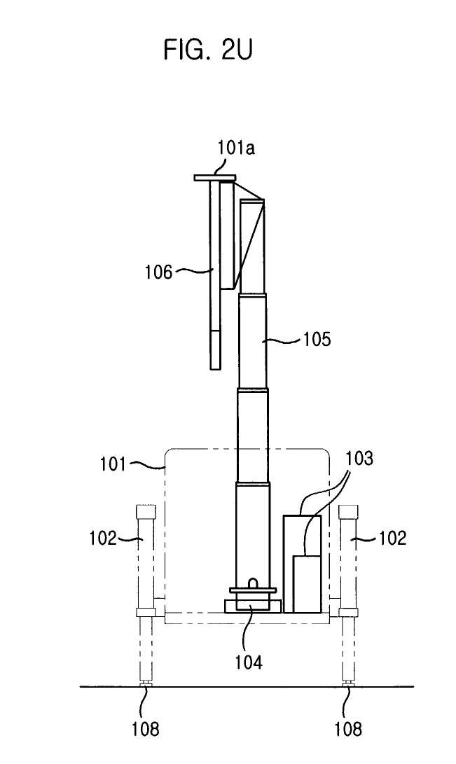

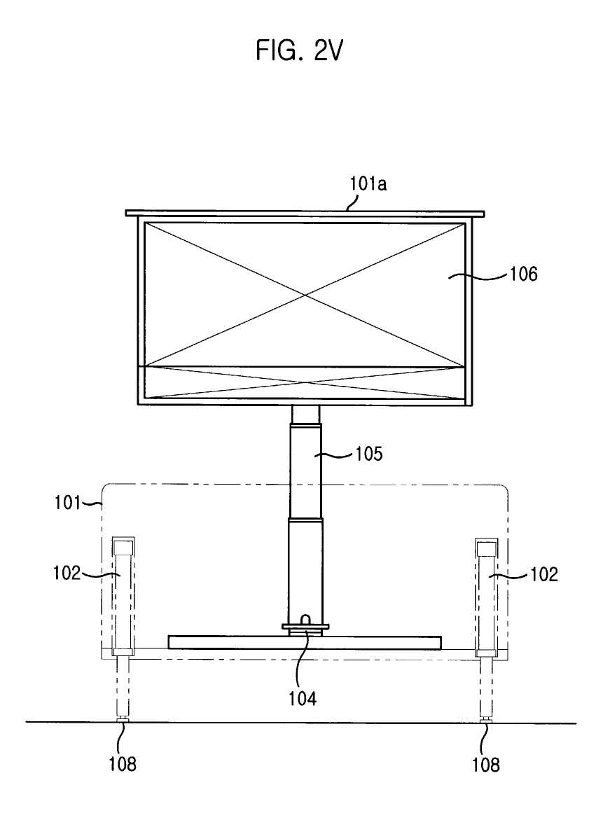

FIGS. 2A to 2V are a view illustrating operation of the mobile advertisement apparatus for vehicle in accordance with a preferred embodiment of the present invention. Referring to FIGS. 2A to 2V, operations of the mobile advertisement apparatus for vehicle are explained as followings.

FIGS. 2A and 2B shows a moving state of the mobile advertisement apparatus for vehicle. Referring to FIGS. 2A to 2B, the plural of bridges 102 are inserted to each left and right side of the container package 101 and the attachable tire 107 is removed when driving the vehicle for eliminating air resistance. When driving the vehicle and the container package 101 is mounted to the vehicle, the electronic display board 105 can be operated by the power generator 103.

The above-mentioned present invention can increase an effectiveness of advertisement and economic efficiency by operating the mobile advertisement apparatus independently of the vehicle used as carrying the mobile advertisement apparatus.

While the present invention has been described with respect to certain preferred embodiments, it will be apparent to those skilled in the art that various changes and modifications may be made without departing from the scope of the invention as defined in the following claims.

What is claimed is:

1. A mobile advertisement apparatus, comprising:
a container package having a rectangular parallelepiped form as outside view with empty internal space and an opening unit equipped on an upper side of the container package for protecting inside of the container package;
a plural of bridges mounted on a left side and right side of the container package and equipping a cylinder load internally, for controlling height and horizon of the container package by raising and descending the cylinder load;
a power generator equipped in internal of the container package, for supplying the power;
a rotator for performing a rotation operation;
a lift equipped at upper side of the rotator and formed as multi-layers variable oil pressure cylinder for performing raising and descending operations;
an electronic display board mounted at upper side of the lift, for displaying images of advertisement by having a plurality of emitting objects on one side;
an attachable tire installed at bottom and outside of the plural of bridges as having a rotation axis, which is erectly to a moving direction of the cylinder load, mounted when the container package is moved in a short distance and removed when a vehicle with the mobile advertisement apparatus is moved in a long distance; and
a supporter equipped at bottom of the cylinder load equipped at the plural of bridges, for bedding the container package to a ground.

2. The apparatus as recited in claim 1, wherein the plural of bridges includes four bridges mounted at each corner of left side and right side of the container package.

3. The apparatus as recited in claim 1, wherein the rotator includes a first gear fixed at the bottom of the lift, a pinion gear interlocked with the first gear and a motor 105 for turning the pinion gear.

4. The apparatus as recited in claim 1, wherein the electronic display board is retractable, by using a restoration spring, is retracted when the electronic display board is in inside of the container package and is extracted when the electronic display board is exposed outside of the container package.
